(19) United States
(12) Patent Application Publication
(10) Pub. No.: US 2007/0241268 A1
(43) Pub. Date: Oct. 18, 2007

(54) Encoder module adapted for a plurality of different resolutions

(76) Inventor: Weng Fei Wong, Penang (MY)

Correspondence Address: Kathy Manke;Avago Technologies Limited, 4380 Ziegler Road, Fort Collins, CO, 80525, US

(21) Appl. No.: 11/403,366

(22) Filed: Apr. 13, 2006

(51) Int. Cl. G01D 5/34

(52) U.S. Cl. 250/231.13

(57) ABSTRACT

A photodetector module and method for making the same are disclosed. The method includes fabricating an integrated circuit substrate having a plurality of light conversion elements thereon, and then covering the substrate with a reticle layer comprising a clear layer and a mask layer. The clear layer has a top surface and a bottom surface, the bottom surface being bonded to the substrate. The top surface is covered with the mask layer. After the reticle layer is bonded to the substrate, the mask layer is processed to provide transparent windows in an opaque layer over the light conversion elements after the substrate is covered with the reticle layer. The windows have a shape such that each light conversion element generates a predetermined signal when a predetermined light signal comprising a repeated pattern of light and dark bands passes over the light conversion element under the window.

### BACKGROUND OF THE INVENTION

Encoders provide a measurement of the position of a component in a system relative to some predetermined reference point. Encoders are typically used to provide a closed-loop feedback system to a motor or other actuator. For example, a shaft encoder outputs a digital signal that indicates the position of the rotating shaft relative to some known reference position that is not moving. A linear encoder measures the distance between the present position of a moveable carriage and a reference position that is fixed with respect to the moveable carriage as the moveable carriage moves along a predetermined path.

An absolute shaft encoder typically utilizes a plurality of tracks arranged on a carrier that is typically a disk that is connected to the shaft. Each track consists of a series of dark and light stripes that are viewed by a detector that outputs a value of digital 1 or 0, depending on whether the area viewed by the detector is light or dark. An N-bit binary encoder typically utilizes N such tracks, one per bit. An incremental encoder typically utilizes a single track that is viewed by a detector that determines the direction and the number of stripes that pass by the detector. The position is determined by incrementing and decrementing a counter as each stripe passes the detector.

To determine the direction of motion, incremental encoders often utilize a system in which an image of a portion of the track is projected onto the surface of a detector that has a plurality of photodetectors such as photodiodes. The surface of each photodetector has an active area that has a shape that is determined by the shape of the bands in the code pattern, the resolution of the encoder, and other factors such as the distance between the code pattern carrier and the detector. The photodetectors must also be positioned relative to one another such that the outputs of the photodetectors can be processed to provide two signals that are out of phase with respect to one another. The direction of travel is ascertained by observing the phase relationship of these signals. This arrangement also has the advantage of improving the resolution of the encoder. However, this arrangement requires that the detector be customized to the particular encoder design.

In both types of encoder, the ultimate resolution is determined by the stripe pattern and size of the detectors used to view the band pattern. To provide increased resolution, the density of the bands must be increased. For example, in a shaft encoder, the number of bands per degree of rotation must be increased. Similarly, in a linear encoder, the number of bands between the limits of the linear motion must be increased. However, there is a practical limit to the density of bands that is set by optical and cost constraints and the physical size of the encoder. This limit applies to both incremental encoders and absolute encoders, since the track having the highest number of bands has the same constraints as the single track of an incremental encoder.

One method for providing increased resolution is to utilize an interpolation scheme to provide an estimate of the position between the edges of the bands. Such schemes also require that the detector used to view at least the highest resolution track be constructed from a plurality of photodetectors that have a size and placement that depends on the particular encoder design.

In the designs discussed above, a custom detector must be provided for each code pattern design. The photodetectors are typically photodiodes that are constructed using conventional integrated circuit fabrication techniques. Since the cost of producing a custom IC for each encoder design is often prohibitive, a scheme for customizing a generic detector module to a particular encoder design is required.

In one scheme, a generic detector having a plurality of photodiodes with active areas that are much larger than the active areas required by any of a plurality of encoder designs is provided. A screen with a window pattern is placed in front of the detectors. The shape and position of the detectors and windows is set to provide photodetectors having the proper active area shape and relative positions.

As noted above, the size and positioning of the windows on the photodiodes depends on the resolution of the encoder and the physical parameters of the system. Hence, this arrangement reduces the problem of providing a custom detector for each design to one of providing a custom screen for each design. However, this scheme still requires the encoder manufacturer to stock a large number of overlay screens and to position and align the screens relative to the photodiodes on the chip.

### SUMMARY OF THE INVENTION

The present invention includes a method of fabricating a photodetector module. The method includes fabricating an integrated circuit substrate having a plurality of light conversion elements thereon, and then covering the substrate with a reticle layer comprising a clear layer and a mask layer. The clear layer has a top surface and a bottom surface, the bottom surface being bonded to the substrate. The top surface is covered with the mask layer. The mask layer is processed to provide transparent windows in an opaque layer over the light conversion elements after the substrate is covered with the reticle layer. The windows have a shape such that each light conversion element generates a predetermined signal when a predetermined light signal comprising a repeated pattern of light and dark bands passes over the light conversion element under the window.

### BRIEF DESCRIPTION OF THE DRAWINGS

FIG. 1 illustrates a transmissive encoder.

FIG. 2 illustrates a reflective encoder.

FIG. 3 illustrates an imaging reflective encoder.

FIG. 4 illustrates a prior art two-channel encoder design.

FIG. 5 is a graph of the amplitude of the output of the photodetectors shown in FIG. 4 as a function of position of the code strip image.

FIG. 6 illustrates the channel A and channel B signals of FIG. 4 when the code strip is moving in the direction shown by arrow 23.

FIG. 7 illustrates an alternative placement for the detectors shown in FIG. 4.

FIGS. 8-9 illustrate a two-channel detector for use in a number of encoders having different resolutions.

FIGS. 10 and 11 illustrate a detector chip according to one embodiment of the present invention

FIG. 12 is a cross-sectional view of an emitter-detector module according to one embodiment of the present invention.

### DETAILED DESCRIPTION OF THE PREFERRED EMBODIMENTS OF THE INVENTION

Refer now to FIGS. 1-3, which illustrate some typical encoder designs. The encoder can be divided into an emitter/detector module 15 and a code wheel or code strip. Module 15 includes an emitter 11 that illuminates a portion of the code strip 12. A detector 13 views the illuminated code strip. The emitter typically utilizes an LED as the light source. The detector is typically based on one or more photodiodes. FIG. 1 illustrates a transmissive encoder. In transmissive encoders, the light from the emitter is collimated into a parallel beam by a collimating optic such as a lens that is part of the emitter. Code strip 12 includes opaque bands 16 and transparent bands 17. When code strip 12 moves between emitter 11 and detector 13, the light beam is interrupted by the opaque bands on the code strip. The photodiodes in the detector receive flashes of light. The resultant signal is then used to generate a logic signal that transitions between logical one and logical zero.

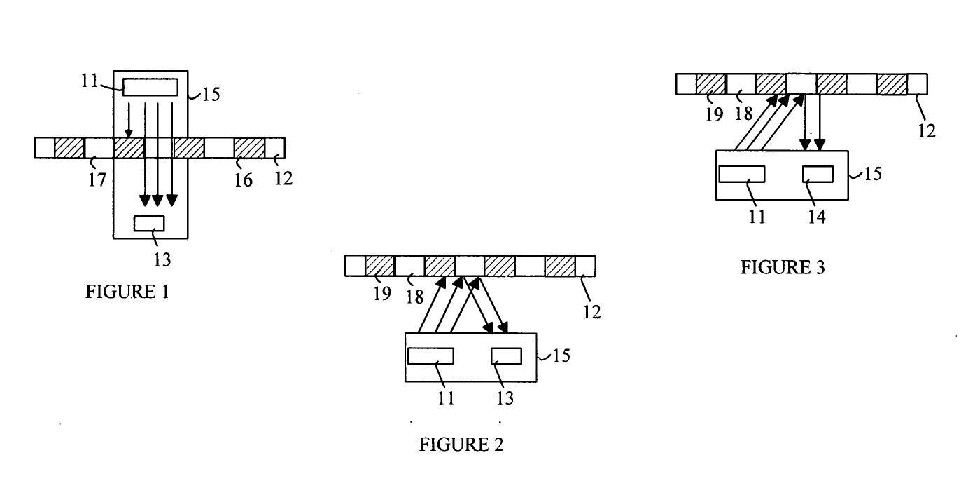

FIG. 2 illustrates a reflective encoder. In reflective encoders, the code strip includes reflective bands 18 and absorptive bands 19. Again, the emitter includes an optic element such as a lens. The light from the emitter is reflected or absorbed by the bands on the code strip. The reflected light is imaged onto the photodiodes in the detector. The output from the photodetectors is again converted to a logic signal.

FIG. 3 illustrates an imaging encoder. An imaging encoder operates essentially the same as the reflective encoder described above, except that module 15 includes imaging optics that form an image of the illuminated code strip on the detector 14.

In each of these types of encoders, an image of one portion of the band pattern is generated on the photosensitive area of a photodiode in an array of photodiodes. To simplify the following discussion, drawings depicting the image of the code strip and the surface area of the photodetectors on which the image is formed will be utilized. In each drawing, the image of the code strip will be shown next to the photodiode array to simplify the drawing. However, it is to be understood that in practice, the image of the code strip would be projected onto the surface of the photodiode array. In addition, to further simplify the drawings, the light source and any collimating or imaging optics are omitted from the drawings.

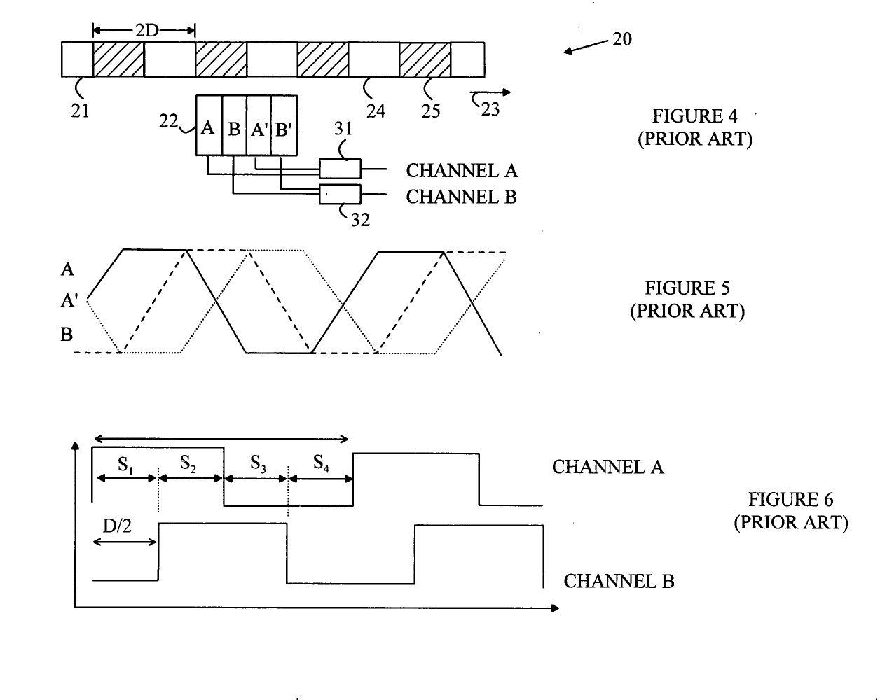

Refer now to FIG. 4, which illustrates a prior art two-channel encoder 20 design that has been utilized in single track linear encoders that detect the relative motion of the code strip. Encoder 20 includes a code strip that is imaged to form an image 21 that is viewed by a detector array 22. The image 21 of the code strip consists of alternating “white” and “black” stripes shown at 24 and 25, respectively. Denote the width of each stripe in the direction of motion of the code strip by D. The direction of motion is indicated by arrow 23. For the purposes of this example, it will be assumed that when a white stripe is imaged on a detector, the detector outputs its maximum signal value, and when a black stripe is imaged on the detector, the detector outputs its minimum value. It will also be assumed that the detector outputs an intermediate value when only a portion of a white stripe is imaged onto the detector.

Detector array 22 is constructed from 4 photodetectors labeled A, A′, B, and B′. Each photodetector has an active area with a width equal to D/2. The detectors are positioned such that the A′ and B′ detectors generate the complement of the signal generated by the A and B detectors, respectively. The outputs of the A, A′, and B photodetectors are shown in FIG. 5, which is a graph of the amplitude of the output of each photodetector as a function of position of the code strip image. To simplify FIG. 6, the output of the B′ photodetector has been omitted.

The signals generated by these detectors are combined by detector circuits 31 and 32 to generate two logic channel signals that are 90 degrees out of phase as shown in FIG. 6. FIG. 6 illustrates the channel A and channel B signals when the code strip is moving in the direction shown by arrow 23 in FIG. 4. If the code strip were to move in the opposite direction, the channel B signal would lead the channel A signal; however, the two signals would still be 90 degrees out of phase.

Circuits for converting the photodiode output signals to the channel signals shown in FIG. 6 are known in the art, and hence, will not be discussed in detail here. For the purposes of this discussion, it is sufficient to note that the channel signal corresponding to a pair of photodiode output signals such as A and A′ switches between logical one and logical zero at the points at which the output of detector A is equal to the output of detector A′.

The two channel signals provide a measurement of the direction of motion of the image of the code strip relative to the detector array. In addition, the two channel signals define 4 states that divide the distance measured by one black and one white stripe into quarters. The 4 states correspond to a two-bit binary number in which the first bit is determined by the value of the channel A signal and the second bit is determined by the value of the channel B signal. Hence, this type of system has an accuracy equal to half of the width of one of the stripes.

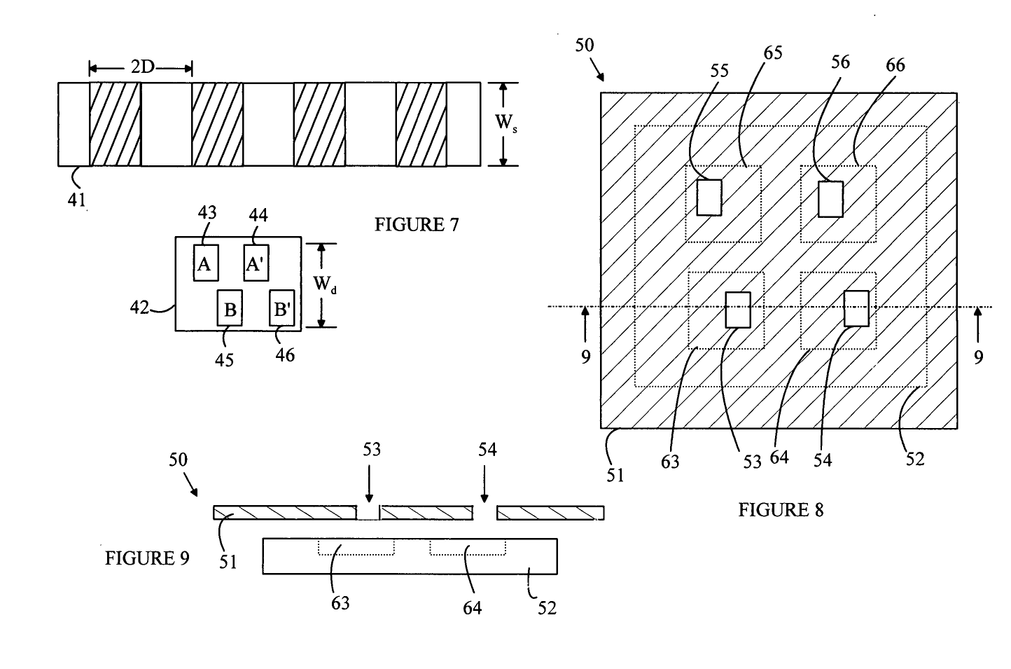

In the embodiment shown in FIG. 4, the detectors are positioned adjacent to one another in a single row. However, other placement options can be utilized in which the individual detectors are separated from each other. Refer now to FIG. 7, which illustrates an alternative placement for the detectors shown in FIG. 4. In this embodiment, the detector 42 is split into 4 photodetectors shown at 43-46 that are arranged in two rows. The code strip image 41 has a width perpendicular to the direction of motion, Wₛ, that is larger than the width of the two rows, W_{d}. Hence, when the code strip image passes over the photodetectors, the photodetectors will be illuminated in the same manner as the photodetectors shown in FIG. 4. It should be noted that there is gap between each of the photodetectors in each of the rows. The distance between the A and A′ photodetectors must be ND where N is an odd integer. Similarly, the distance between the B and B′ photodetectors must be N′D where N′ is an odd integer. It should be noted that N need not be equal to N′. Finally, the distance between the A detector and the B detector must be D/2+2N″D where N″ is an integer. It should also be noted that the number of rows could be as large as 4, and the rows can be separated by gaps provided the code strip image is sufficiently wide that all rows are covered when an image of a band passes over the photodetectors. If these spacing criteria are satisfied, the detectors will provide the desired signals.

Refer now to FIGS. 8-9, which illustrate a two-channel detector for use in a number of encoders having different resolutions, and hence, different spacing requirements for the photodetectors. FIG. 8 is a top view of detector 50, and FIG. 9 is a cross-sectional view through line 9-9 shown in FIG. 8. Detector 50 is constructed from a screen 51 and a chip 52. Chip 52 includes four photodiodes 63-66. The positions and sizes of the effective active areas of the photodiodes are determined by openings in screen 51. The openings corresponding to photodiodes 63-66 are shown at 53-56, respectively. Each of the photodiodes has an active area that is larger than the active area needed to implement the detector. Furthermore, the photodiode active areas are large enough to accommodate a range of window sizes and spacings, and hence, this arrangement can be utilized with a range of encoders having different resolutions and other physical parameters by using the same chip with different screens.

While the screen-based embodiments provide a means of using the same IC detector chip in a variety of encoders, this solution still requires that a custom screen be provided for each design. Hence, the manufacturer must inventory a number of screens for the various encoders utilized by that manufacturer. In addition, the manufacturer of the encoder must provide a means for mounting the screen relative to the chip and the other components in the encoder. Finally, when a new encoder is designed, the manufacturer must wait for a new screen to be provided, which increases the time needed to implement a product that requires a new encoder design.

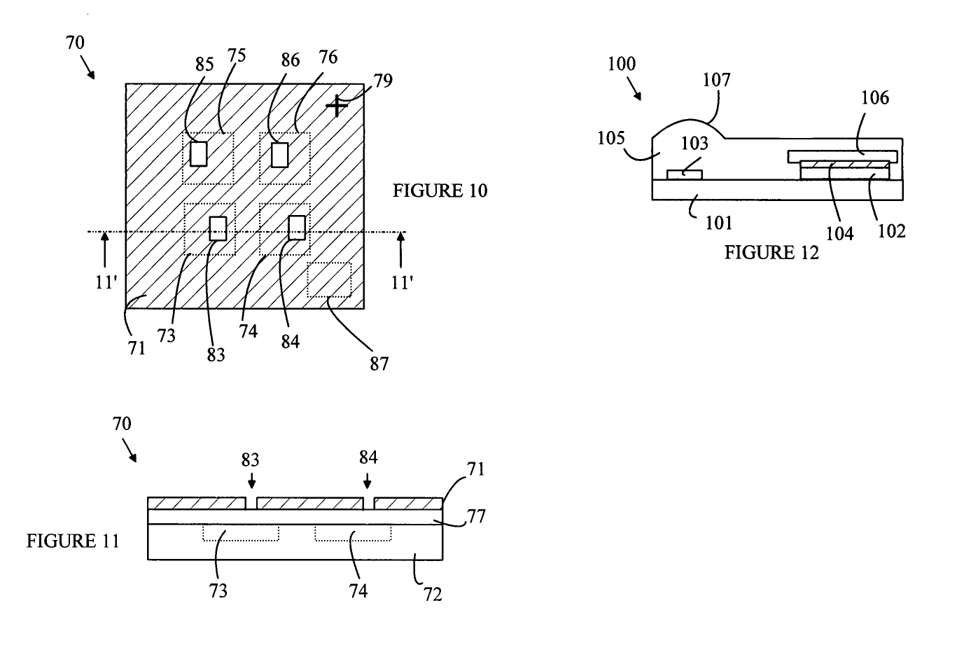

Refer now to FIGS. 10 and 11, which illustrate a detector chip according to one embodiment of the present invention. FIG. 10 is a top view of chip 70, and FIG. 11 is a cross-sectional view of chip 70 through line 11′-11′ shown in FIG. 10. Detector chip 70 includes a semiconductor chip having 4 photodiodes 73-76 fabricated in a substrate 72. A clear buffer layer 77 is deposited over the photodiodes to protect the photodiodes. A thin metallic layer 71 is deposited on buffer layer 77. Metallic layers of chrome or TiW/Al are suitable for layer 71; however, any layer that can be etched can be utilized. Embodiments with layers having a thickness of 10 to about 10,000 Angstroms can be etched using the laser etching.

The windows 83-86 that define the active location and size of the active areas of the photodiodes are etched in layer 71 to form a reticle layer. The areas of the photodiodes are large enough to accommodate a plurality of encoder resolutions and other physical parameters.

If relatively small numbers of encoders are to be fabricated, the photodetector modules can be individually etched using a laser. In this case, a fiducial mark 79 can be included in the metallic layer 71 to provide a reference point for aligning the laser etching equipment such that the windows are properly aligned with respect to the underlying photodiodes.

However, if large numbers are to be utilized, the windows can be etched at the wafer level using conventional lithographic procedures. In this case, the mask layer can be constructed from any opaque material that can be patterned to provide the windows. For example, a conventional photo resist layer can be patterned. The cured photo resist could be used as the mask after the window portions have been removed using conventional semiconductor processing techniques. After the windows have been formed, the wafer is diced to provide the individual photodetector modules. It should be noted that the window creation and dicing operation could be performed by the manufacturer of the encoder or by a supplier of the detector modules.

In both cases, the encoder fabricator only needs to inventory the blank photodiode modules. That is, the modules with the mask layer covering the photodiodes. The fabricator then processes the blank photodiode modules to provide the desired windows in the mask layer. If the processing operates by removing a portion of the layer using laser etching, the window size and shape are specified by inputting data to the laser controller, and hence, the lead times associated with making new masks are substantially reduced.

It should be noted that the present invention avoids the problems associated with the alignment of a screen having the windows thereon with an underlying photodetector module. The etching of the windows is carried out using conventional etching or scribing processes that make use of alignment marks on the chips or wafers. These marks are derived from the wafer alignment marks used in the fabrication of the photodiodes on the wafer. Hence, the windows can be placed with high accuracy with respect to one another and with respect to the photodiodes. Uncertainties associated with photodetector modules based on a separate screen that is aligned to a photodiode module are substantially reduced. The manufacturer of the encoder only needs to align the completed photodetector module with the code strip.

In one embodiment of the present invention, the integrated circuit substrate also includes a controller 87 that is connected to the photodiodes. Controller 87 can generate the channel signals discussed above and perform interpolation in embodiments that utilize an interpolation scheme. Such interpolation embodiments will be discussed in more detail below.

In the above-described embodiments, the mask layer was formed on the integrated circuit substrate having the photodiodes during the fabrication of the substrate by depositing two layers on the substrate. However, embodiments in which a clear layer covered with a metallic layer is affixed to the chip after the chip has been fabricated and separated from the wafer can also be constructed. For example, a clear plate having a metallic layer on the top surface can be bonded to a chip having the photodiodes after the chip has been fabricated and singulated.

It should also be noted that semiconductor chips are often covered with a final layer of SiO₂ to protect the integrated circuit components. Hence, embodiments of the present invention in which the mask layer is deposited over this clear layer can also be constructed.

The embodiments described above have utilized rectangular windows in the mask layer. The resultant detectors are used in linear encoders in which the code pattern carrier has rectangular bands. However, other window shapes can be used to implement other types of encoders. For example, shaft encoders utilize a code pattern carrier in the form of a code wheel in which the alternating bands have a shape defined by the area between circular arcs having the same center and two radial lines passing through that center. In such encoders, the windows would have a similar shape.

In some applications, the resolution provided by a two-channel encoder such as those described with reference to FIGS. 4-6 above is insufficient, and a code pattern carrier having a larger number of bands is not practical given the constraints imposed by manufacturing costs or other factors. In such cases, some form of interpolation must be provided. The two-channel encoder discussed above actually provides an interpolation factor of 2, since it provides two state changes when one band passes over the detector. Multiple channel encoders based on higher numbers of channels can be utilized to provide some additional interpolation; however, additional photodetectors are required, which increase the cost of the encoder. In addition, there are physical limits that set an upper limit on the number of channels that can be implemented. Hence, this solution is not always possible.

In some cases, an interpolation scheme that operates on two channel signals but provides a higher interpolation factor is satisfactory. One such scheme utilizes detectors that generate a sinusoidal signal as the code pattern passes over the detector. In one such scheme, two channel signals that are sinusoids and which differ in phase by 90 degrees are created in a manner analogous to the two channel signals discussed above. By determining the points at which a signal that has an amplitude equal to a fraction of one of these signal crosses the other signal, intermediate interpolation points can be provided. It can be shown that such sinusoidal signals can be generated by utilizing a window of the appropriate shape in the mask layer.

In the above-described embodiments of the present invention, the mask layer included an opaque layer that was optically processed to provide windows of the appropriate shape and having the desired relative positions over the photodiodes. However, embodiments in which the photodiodes are covered by a clear layer that is rendered opaque by optical processing can also be constructed. For example, the layer could include a compound that becomes opaque in the areas exposed to light. Silver halide, photoresist, and photoimageable dyes and pigments are known to the art.

In some applications, the encoder manufacturer wishes to receive a detector module that includes the mask layer in an unprocessed form under an encapsulation layer that protects the photodetector. The manufacturer then provides the optical processing to create the clear window. Refer now to FIG. 12, which is a cross-sectional view of an emitter-detector module according to one embodiment of the present invention. Module 100 includes a light source 103 and a photodetector 102 that are mounted on a base 101 and encapsulated in a clear layer 105. Module 100 is adapted for use in a reflective encoder, and hence, requires some form of imaging optics. In module 100, the optical imaging of light source 103 onto the photodetector 102 is provided by a lens 107 that is molded into the surface of layer 105. The region of the encapsulation layer that overlies photodetector 102 is planar to facilitate the patterning of a mask layer 104. If mask layer 104 is etched using a laser as described above, an air space 106 is molded into layer 105 to facilitate the removal of the ablated material.

In the case of a transmissive encoder, the detector is normally packaged separately from the light source. The detector typically includes an imaging lens that forms an image of the collimated light on the photodetector. A detector design similar to that shown in FIG. 12 can be utilized. In this case, however, the area of the encapsulating layer overlying the photodetector would have a lens formed therein. This lens forms an image of a collimated light source on the surface of the mask layer. Hence, the mask laser can be etched using a laser that generates a collimated beam and a mask that duplicates the band of the code strip or disk that will be utilized with the detector.

The above-described embodiments utilize photodiodes as the light conversion element. However, embodiments that utilize other light conversion elements such as phototransistors can also be utilized provided those elements have a monotonic relationship between the current generated when the device is illuminated with a light signal and the intensity of that light signal per unit area of illumination times the illuminated area.

Various modifications to the present invention will become apparent to those skilled in the art from the foregoing description and accompanying drawings. Accordingly, the present invention is to be limited solely by the scope of the following claims.

What is claimed is:

1. A method of fabricating a photodetector module, said method comprising:
fabricating an integrated circuit substrate having a plurality of light conversion elements thereon;
covering said substrate with a reticle layer comprising a clear layer and a mask layer, said clear layer having a top surface and a bottom surface, said bottom surface being bonded to said substrate and said top surface being covered with said mask layer; and
processing said mask layer to provide transparent windows in an opaque layer over said light conversion elements after said reticle layer is bonded to said substrate, said windows having a shape such that each light conversion element generates a predetermined signal when a predetermined light signal comprising a repeated pattern of light and dark bands passes over said light conversion element under said window.

2. The method of claim 1 wherein said reticle layer comprises a preformed clear substrate covered with said mask layer.

3. The method of claim 1 wherein said processing of said mask layer comprises selectively exposing said mask layer to light from a laser.

4. The method of claim 3 wherein said mask layer comprises an opaque material that is rendered transparent in areas that are exposed to said light.

5. The method of claim 4 wherein said windows are opened by laser etching said mask layer.

6. The method of claim 1 wherein said mask layer comprises a layer of photoresist.

7. The method of claim 5 wherein said mask layer comprises a layer of metal.

8. The method of claim 1 wherein said light conversion elements are larger than said windows.
